(19) United States
(12) Patent Application Publication
(10) Pub. No.: US 2008/0265787 A1
(43) Pub. Date: Oct. 30, 2008

(54) LIGHTING SYSTEMS FOR FOLDABLE ENCLOSURES AND METHODS OF USE

(75) Inventor: Aaron J. Golle, Shakopee, MN (US)

Correspondence Address: SCHWEGMAN, LUNDBERG & WOESSNER, P.A., P.O. BOX 2938, MINNEAPOLIS, MN, 55402, US

(73) Assignee: Safe Lites, LLC

(21) Appl. No.: 12/103,471

(22) Filed: Apr. 15, 2008

Related U.S. Application Data
(60) Provisional application No. 60/912,011, filed on Apr. 16, 2007.

(51) Int. Cl. G09G 3/10

(52) U.S. Cl. 315/169.3

(57) ABSTRACT

There is provided method and apparatus for illuminating a foldable enclosure.

### RELATED APPLICATIONS

This patent application claims the benefit of priority, under 35 U.S.C. Section 119(e), to U.S. Provisional Patent Application Ser. No. 60/912,011, filed on Apr. 16, 2008, which is incorporated herein by reference in its entirety.

### TECHNICAL FIELD

The present invention pertains generally to indoor illumination systems, and more particularly to methods and articles pertaining to illuminating tents or other portable structures and uses thereof.

### BACKGROUND

Often it is desirable to illuminate the inside of a tent, portable ice fishing shelter or other such portable shelter.

### BRIEF DESCRIPTION OF THE DRAWINGS

FIGS. 1 and 2 illustrate an ice fishing enclosure according to one example embodiment of the inventive subject matter.

FIGS. 3 and 4 illustrate a tent according to one example embodiment of the inventive subject matter.

### DETAILED DESCRIPTION

In the following detailed description of the inventive subject matter, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention.

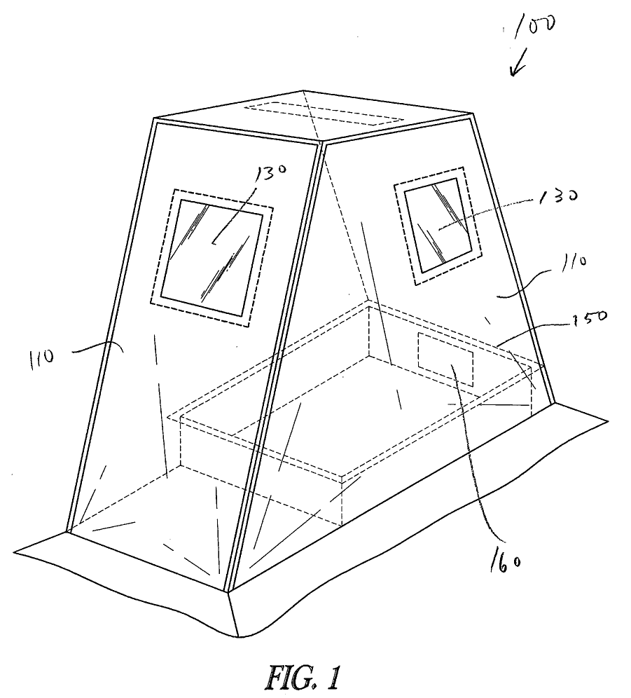

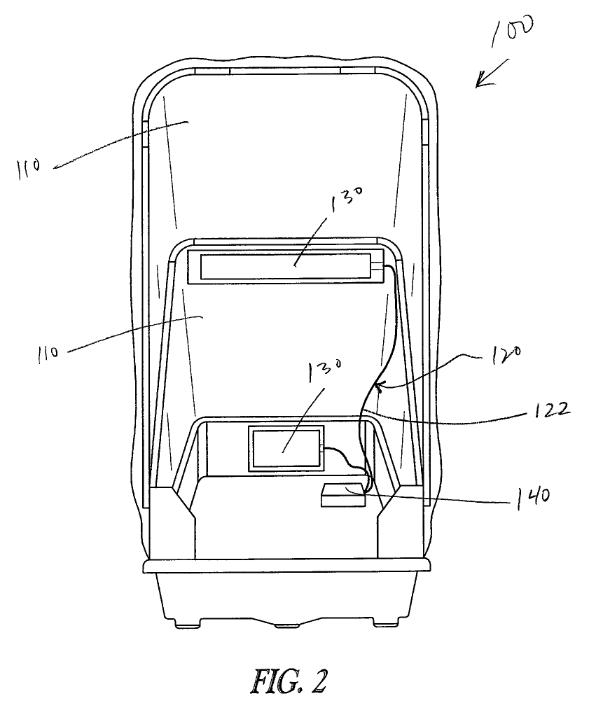

FIGS. 1 and 2 illustrate a portable ice fishing house or enclosure 100 including collapsible walls 110, for example constructed of light weight fabric that may be wind resistant or water resistant or waterproof. An electroluminescent (EL) lighting system 120 including conductors 122 is provided inside the enclosure 100, wherein flexible EL lighting panels 130 that provide EL light are attached to the walls 110 so that when the walls 110 are collapsed or folded up, the lighting panels 130 may bend and fold together with the walls 110. Lighting panels 130 are powered with an EL power unit 140 that may include batteries and an inverter to generate alternating current power to the EL lighting panels 130, or generate any other suitable power to the panels 130. Enclosure 100 further may include an ice fishing deck 150 that may include an EL lighting panel 160 that is under the surface of the deck 150. Power unit 140 may be removed from the enclosure 100 prior to folding it up and packing it away, or left in the enclosure 100 when it is packed up.

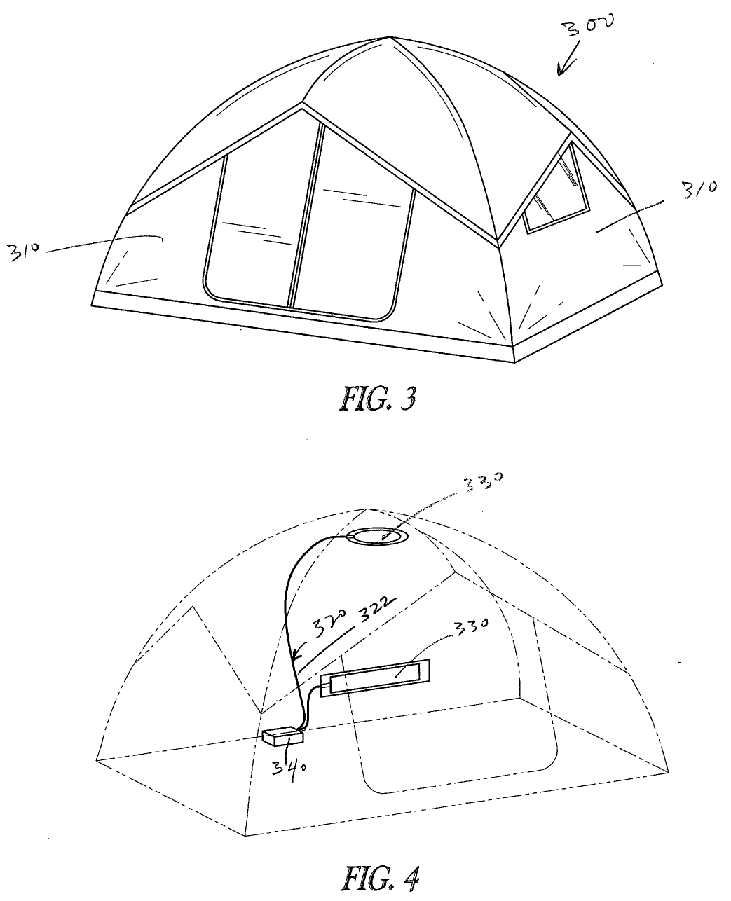

FIGS. 3 and 4 illustrate a tent 300 including collapsible walls 310, for example constructed of light weight fabric that may be wind resistant or water resistant or waterproof. An electroluminescent (EL) lighting system 320 including conductors 322 is provided inside the tent 300, wherein flexible EL lighting panels 330 that provide EL light are attached to the walls 310 so that when the walls 310 are collapsed or folded up, the lighting panels 330 may bend and fold together with the walls 310. Lighting panels 330 are powered with an EL power unit 340 that may include batteries and an inverter to generate alternating current power to the EL lighting panels 330, or generate any other suitable power to the panels 330. Power unit 340 may be removed from the tent 300 prior to folding it up and packing it away, or left in the tent 300 when it is packed up.

According to one example embodiment, the power unit 140 or 340 includes rechargeable batteries. In another embodiment, it is powered by disposable batteries.

Examples of EL lighting assemblies that are flexible and may be suitable for such application are disclosed in U.S. patent application Ser. No. 10/707,146, the entire disclosure of which is hereby incorporated herein by reference. However, any suitable EL lighting arrangement may be used and the inventive subject matter is in no way limited in that respect.

Although specific embodiments have been illustrated and described herein, it will be appreciated by those of ordinary skill in the art that any arrangement that may achieve the same or similar purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the inventive subject matter includes any other applications in which the above structures and fabrication methods are used. The scope of the inventive subject matter should be determined with reference to the appended claims, along with the full scope of equivalents to which such claims are entitled.

What is claimed is:

1. Apparatus comprising:
a foldable shelter with at least one foldable wall constructed of fabric; and
a flexible EL lighting panel attached to the wall such that the EL lighting panel is attached in a folded state and an unfolded state, with the EL lighting panel at least partially folded in the folded state.

2. The apparatus of claim 1, further comprising a power unit coupled to the shelter, the power unit to illuminate the EL lighting panel via an inverter of the power unit.

3. The apparatus of claim 2, wherein the power unit comprises a removable power unit.

4. The apparatus of claim 2, further comprising a conductor to conduct energy between the power unit and the EL lighting panel.

5. Apparatus comprising:
a collapsible ice fishing shelter including an ice fishing deck; and
a flexible EL lighting panel attached to the ice fishing shelter such that the EL lighting panel is attached in a folded state and an unfolded state.

6. The apparatus of claim 5, with the EL lighting panel is at least partially folded in the folded state.

7. The apparatus of claim 5, wherein the EL lighting panel is attached under the surface of the ice fishing deck.

8. The apparatus of claim 7, further comprising a further EL lighting panel attached to a wall of the ice fishing deck.

9. The apparatus of claim 8, wherein the further EL lighting panel is attached inside the collapsible ice fishing shelter.

10. Apparatus comprising:
a foldable tent with at least one foldable wall constructed of fabric; and
a flexible EL lighting panel attached to the wall such that the EL lighting panel is attached in a folded state and an unfolded state.

11. The apparatus of claim 10, with the EL lighting panel is at least partially folded in the folded state.

12. The apparatus of claim 10, wherein the EL lighting panel is attached to a side wall of the tent.

13. The apparatus of claim 12, further comprising a further EL lighting panel attached to a top of the tent.
